(19) United States
(12) Patent Application Publication
(10) Pub. No.: US 2025/0158270 A1
(43) Pub. Date: May 15, 2025

(54) STRATIFIED ANTENNA FOR WRIST-WEARABLE DEVICES

(71) Applicant: Meta Platforms Technologies, LLC, Menlo Park, CA (US)

(72) Inventors: Eduardo Jorge Da Costa Bras Lima, Santa Clara, CA (US); Yonghua Wei, San Diego, CA (US); Md Rashidul Islam, Fremont, CA (US); Chia-Wei Liu, Newark, CA (US); Joung Sub Shin, Irvine, CA (US); Zhong Ji, San Jose, CA (US)

(21) Appl. No.: 18/505,340

(22) Filed: Nov. 9, 2023

(51) Int. Cl. H01Q 1/27; G04G 17/04; G04G 21/02; H01Q 1/48

(52) U.S. Cl. CPC H01Q 1/273; G04G 17/04; G04G 21/02; H01Q 1/48

(57) ABSTRACT

The disclosed wireless antenna may include a stratified architecture that electrically isolates an antenna radiating element from a ground plane. For example, the disclosed wireless antenna may be included in a wearable device such that the antenna radiating element is capacitively coupled with the bare skin of the wearer. A slot or cleared volume between the antenna radiating element and the ground plane causes electrical fields to close between the antenna radiating element—effectively enlarged by the bare skin of the wearer—and the ground plane. By clearly separating the antenna radiating element and the ground plane and coupling the antenna radiating element to conductive human tissue, the disclosed wireless antenna significantly improves performance at low frequencies such as LTD low bands. Various other methods, systems, and computer-readable media are also disclosed.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a front view of an example implementation of an antenna architecture for a stratified antenna for wrist-wearable devices.

FIG. 2A is a perspective view of an example implementation of an antenna architecture for a stratified antenna for wrist-wearable devices.

FIG. 2B is a bottom-perspective view of the example implementation of the antenna architecture illustrated in FIG. 2A.

FIG. 2C is a bottom view of the example implementation of the antenna architecture illustrated in FIG. 2A.

FIG. 2D is an open view of the example implementation of the antenna architecture illustrated in FIG. 2A.

FIG. 3A is a perspective view of another example implementation of an antenna architecture for a stratified antenna for wrist-wearable devices.

FIG. 3B is a bottom-perspective view of the example implementation of the antenna architecture illustrated in FIG. 3A.

FIG. 3C is a bottom view of the example implementation of the antenna architecture illustrated in FIG. 3A.

FIG. 3D is an open view of the example implementation of the antenna architecture illustrated in FIG. 3A.

FIGS. 4A and 4B illustrate example tuning element architectures for use in connection with the stratified antenna for wrist-wearable devices disclosed herein.

FIG. 5 illustrates a wrist-wearable device including the stratified antenna architecture being worn by a user.

FIGS. 6A and 6B are illustrations of an exemplary human-machine interface configured to be worn around a user's lower arm or wrist.

FIGS. 7A and 7B are illustrations of an exemplary schematic diagram with internal components of a wearable system.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Form factors become more challenging and problematic as personal electronics become smaller and more powerful. For example, personal electronics such as smart wearables are often small (e.g., the size of a watch), but include a wide array of features such as network connectivity, sensor panels, near-field communication, and so forth. Often, these small devices also include wireless antennas. Despite this, the small form factor of personal devices such as smartwatches present significant challenges in connection with certain telecommunications standards that operate at low bands such as long-term evolution (LTE) that operate at 600-960 MHz. Moreover, such small form factors often constrain other technologies such as the global positioning system (GPS), which operates at bands slightly higher than LTE (e.g., 1.2 MHz-1.5 MHz). Enlarging these personal devices to improve low and mid-band transmission, however, negatively impacts user experience.

In light of this, the present disclosure is generally directed to a stratified antenna architecture that maximizes antenna volume in computing devices with small form factors, such as smartwatches. As will be explained in greater detail below, implementations of the present disclosure may include a stratified antenna where the radiating antenna element is electrically separated from the ground plane. For example, implementations of the present disclosure may include a stratified antenna where the ground plane is positioned above, but physically and electrically separated from, the radiating antenna element. Furthermore, implementations of the present disclosure may also be configured such that the radiating antenna element is capacitively coupled with an area of a user's bare skin-effectively enlarging the volume of the antenna. In one or more implementations, this significantly improves the network performance of small form factor computing devices at low frequencies such as LTE low bands, and at mid frequencies such as GPS bands.

Features from any of the embodiments described herein may be used in combination with one another in accordance with the general principles described herein. These and other embodiments, features, and advantages will be more fully understood upon reading the following detailed description in conjunction with the accompanying drawings and claims.

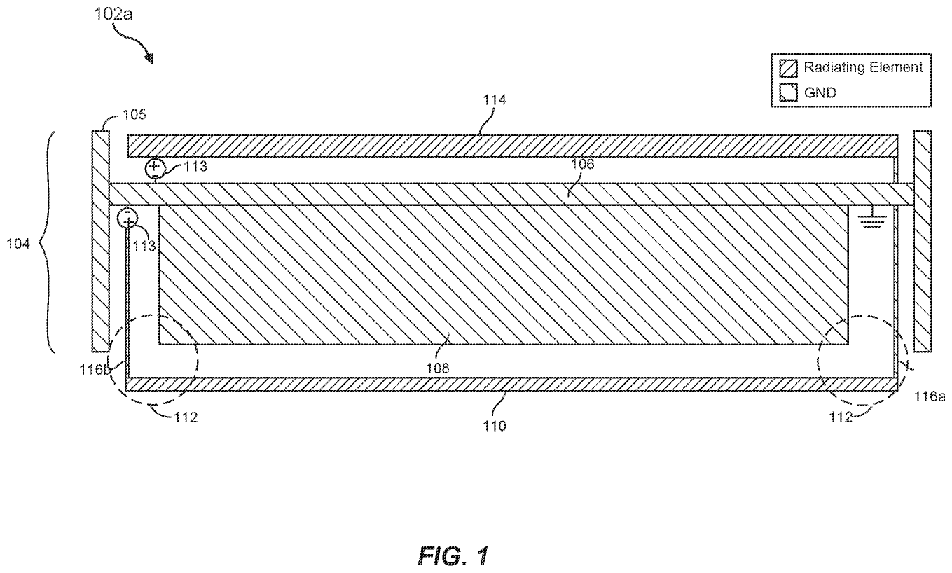

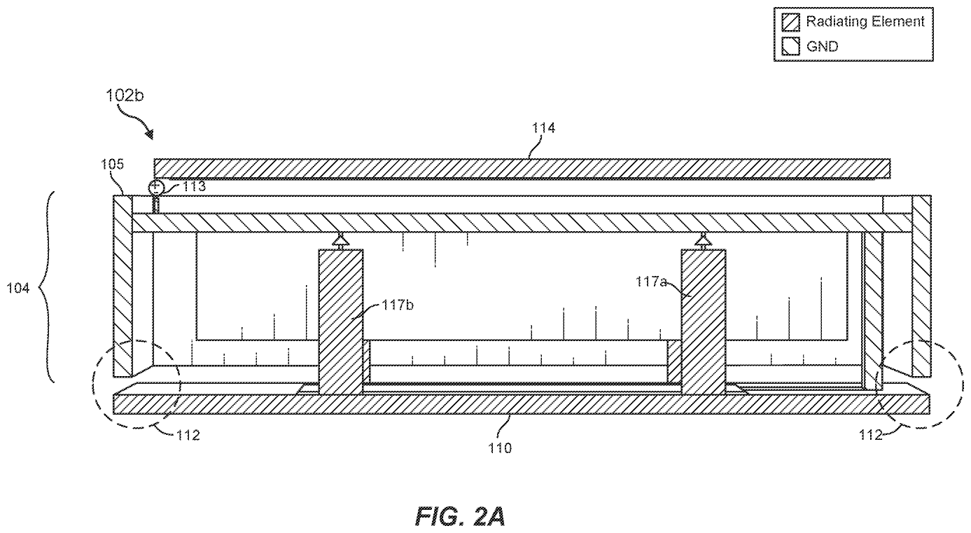

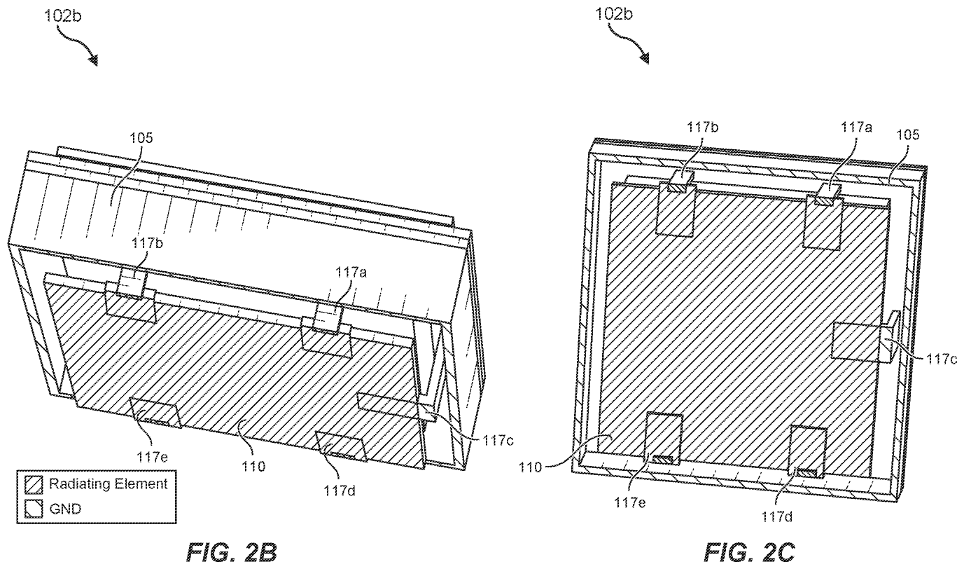

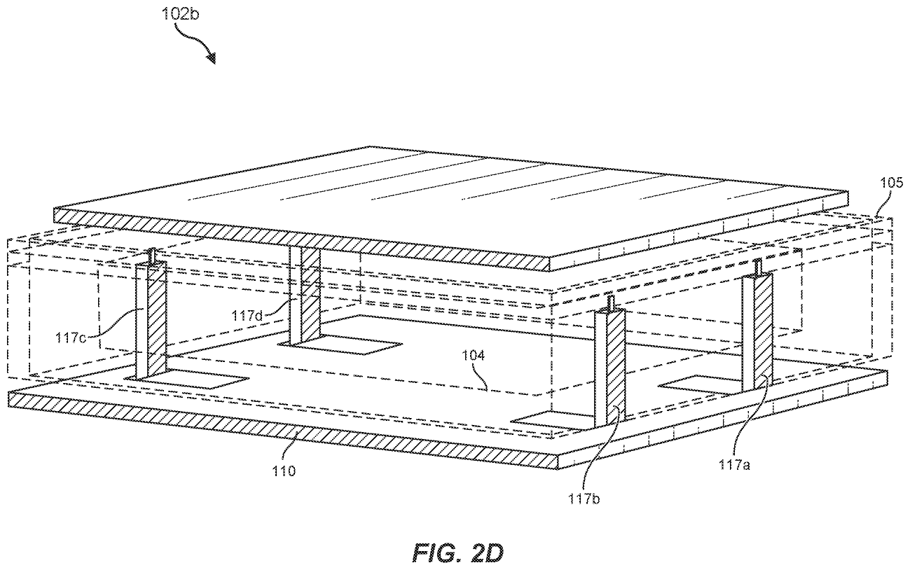

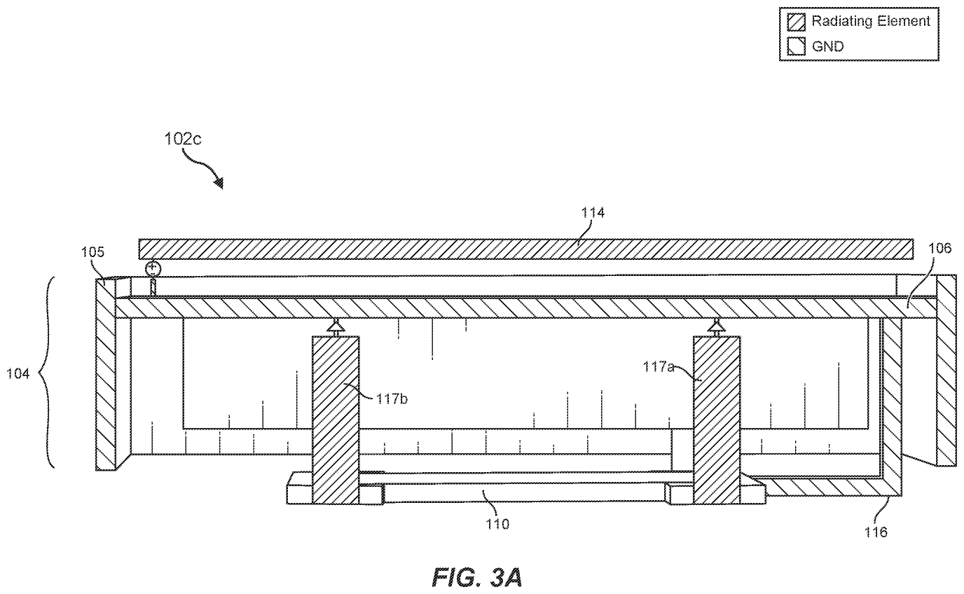

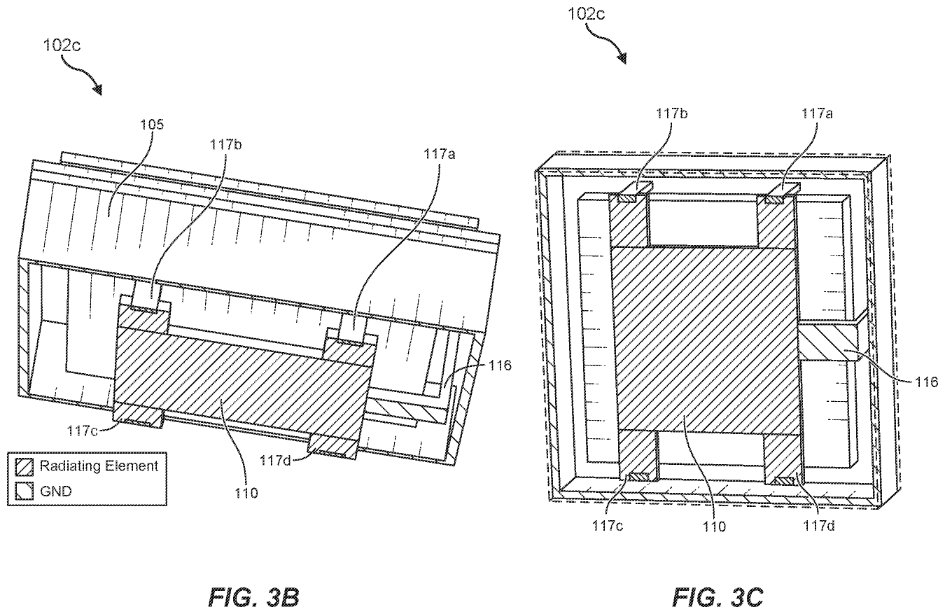

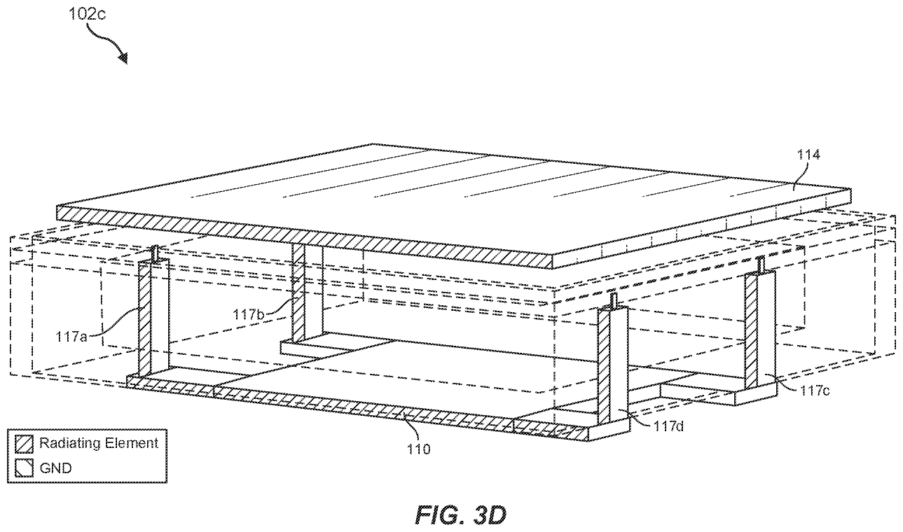

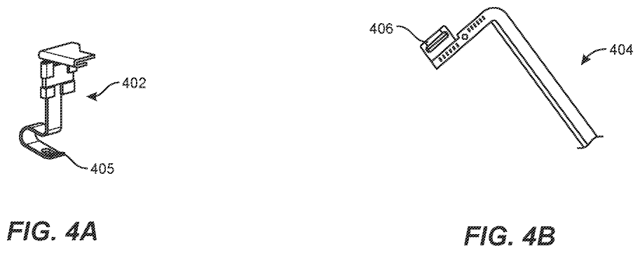

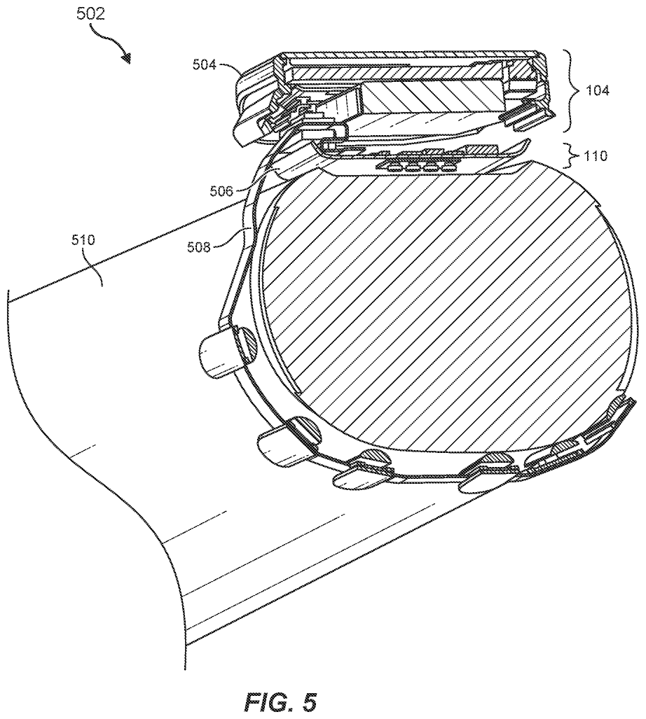

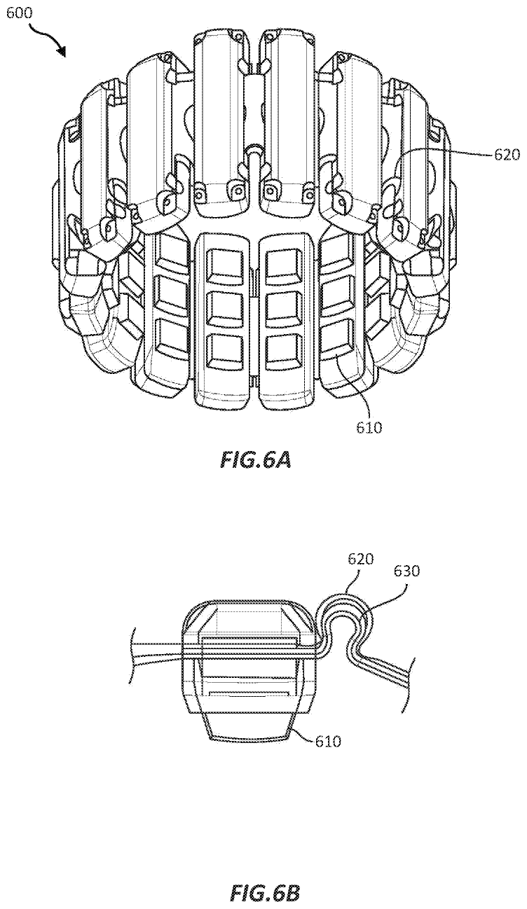

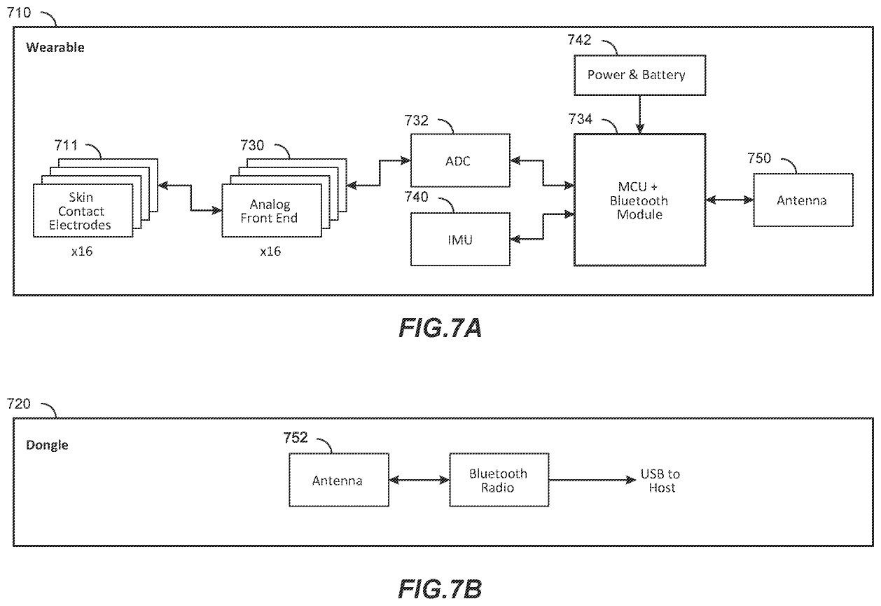

The following will provide, with reference to FIGS. 1-7A, detailed descriptions of a wireless antenna featuring a stratified architecture that electrically isolates an antenna radiating element from the ground plane. For example, FIG. 1 shows a front view of an example implementation of the disclosed wireless antenna. FIGS. 2A-2D illustrate another example implementation of the wireless antenna including tuning elements extending perpendicularly from the antenna radiating element. FIGS. 3A-3D illustrate another example implementation of the wireless antenna including an antenna radiating element with reduced size. FIGS. 4A and 4B illustrate example architectures for tuning elements used in connection with the wireless antenna. FIG. 5 illustrates the wireless antenna featuring the stratified architecture integrated into a wrist-wearable device and worn by a user. FIG. 6A illustrates an exemplary human-machine interface, while FIG. 6B illustrate a cross-sectional view of the same. FIGS. 7A and 7B illustrate an exemplary schematic diagram with internal components of a wearable system with EMG sensors.

In more detail, FIG. 1 shows a front view of an example implementation of wireless antenna featuring a stratified architecture. For example, as shown in FIG. 1, the wireless antenna 102a includes a ground plane 104 and an antenna radiating element 110. In one or more implementations, the ground plane 104 includes at least an enclosure 105, a main logic board 106, and a battery 108. In additional implementations, the ground plane 104 is maximized by connecting all additional modules (e.g., speaker, microphones, camera, flexes, enclosure) as a single block within the ground plane 104 at identical potentials.

As further shown in FIG. 1, the wireless antenna 102a includes the antenna radiating element 110 positioned below the ground plane 104 and electrically separated from the ground plane 104 by the cleared volumes 112. In one or more implementations, the antenna radiating element 110 is positioned such that it can come in direct contact with tissue (e.g., bare skin) of a user. In this configuration, the antenna radiating element 110 is capacitively coupled to the user's tissue, and the user's tissue acts as a parasitic element to the antenna radiating element 110. For example, the user's tissue is conductive and has high permittivity such that the volume of the antenna radiating element 110 is increased.

More specifically, the radiation from the antenna radiating element 110 can originate from the cleared volumes 112 (e.g., electrical separations), by the electrical fields closing from the antenna radiating element 110 to the ground plane 104. For example, the electrical fields will close from the ground plane 104 to the antenna radiating element 110, as well as to the user's tissue below the antenna radiating element 110—which is a much larger surface. As such, the volume of the antenna radiating element 110 increases, which further increases the efficiency of the antenna radiating element 110.

In one or more implementations, the wireless antenna 102a further includes flexes 116a and 116b. In some implementations, one or more of the flexes 116a, 116b may be adjacent to a feed location, such as the feed location 113. In at least one implementation, the flexes 116a and 116b can serve to physically, but not electrically, connect the components of the ground plane 104 with the antenna radiating element 110 within a computing device such as a wrist-wearable device. As shown in FIG. 1, the flexes 116a, 116b may also serve to ensure the cleared volumes 112 and feed location 113 around and between the ground plane 104 and the antenna radiating element 110.

In additional implementations, the flexes 116a, 116b may electrically connect the antenna radiating element 110 and the ground plane 104 or may physically connect the antenna radiating element 110 and the ground plane 104. With no electrical connection between the antenna radiating element 110 and the ground plane 104, the antenna radiating element 110 acts as a patch antenna coupled to the user's arm. When the flexes 116a, 116b electrically connect the antenna radiating element 110 and the ground plane 104, the wireless antenna 102a resembles a shorted patch antenna. In that implementation, an extra ground will correspond to the current's path from the antenna radiating element 110 to the ground plane 104 via the flexes 116a, 116b.

In at least one implementation, as further shown in FIG. 1, the wireless antenna 102a may further include a second antenna radiating element 114. In one or more implementations, as discussed above, the antenna radiating element 110 may have a strong dependence on a capacitive coupling with tissue (e.g., bare skin) of a user to increase the volume and efficiency of the antenna radiating element 110. In at least one implementation, the second antenna radiating element 114 may have minimal dependence on the user because its positioning ensures that the antenna field distribution is not affected by the user's tissue. Due to the limited gap between the second antenna radiating element 114 and the main logic board 106, the second antenna radiating element 114 is more suited to operate at high frequency bands (e.g., WiFi, ultrawide band), while the antenna radiating element 110 may operate at low frequency bands (e.g., LTE, global positioning system). As with the positioning of the antenna radiating element 110, the second antenna radiating element 114 may also be positioned such that it is electrically separated from the ground plane 104 by a slot or cleared volume (e.g., such as the cleared volume 112).

In one or more implementations, the antenna radiating element of a stratified antenna can include one or more tuning elements. For example, FIG. 2A is a cross-sectional view of an example implementation of wireless antenna 102b with a stratified architecture. As shown, the antenna radiating element 110 of the wireless antenna 102b can include tuning elements 117a and 117b extending perpendicularly from the antenna radiating element 110. In one or more implementations, the tuning elements 117a, 117b serve to adjust the frequency of the antenna radiating element 110. In this configuration, the stratified wireless antenna 102b further includes the cleared volumes 112 between the enclosure 105 of the ground plane 104 and the antenna radiating element 110. Moreover, the wireless antenna 102b also includes the feed location 113 between the second antenna radiating element 114 and the ground plane 104.

FIGS. 2B and 2C show bottom perspective views of the stratified wireless antenna 102b. As shown, the wireless antenna 102b can include tuning elements 117a, 117b, 117c, 117d, and 117e positioned along the perimeter of the antenna radiating element 110. In some implementations, the number and placement of the tuning elements 117a-117e can serve to adjust and/or strengthen the antenna radiating element 110 along the bottom of the wireless antenna 102b. In additional implementations, the wireless antenna 102b may include fewer tuning elements or more tuning elements. Additionally, in further implementations, tuning elements may be positioned equidistantly along the perimeter of the wireless antenna 102b or unevenly along the perimeter of the wireless antenna 102b.

FIG. 2D is an open perspective view further showing the tuning elements 117a-117d extending perpendicularly from the antenna radiating element 110 of the stratified wireless antenna 102b. As shown, the tuning elements 117a-117d can be positioned at a measured set-back along the perimeter of the antenna radiating element 110. Furthermore, the tuning elements 117a-117d can follow a perimeter of the ground plane 104, while remaining electrically separated from the enclosure 105 (e.g., part of the ground plane 104). In this embodiment, the enclosure 105 surrounds the tuning elements 117a-117d while maintaining the gap or slot between the enclosure 105 and the antenna radiating element 110.

The example illustrated in FIGS. 2A-2D features an antenna radiating element 110 that is roughly the same size as the enclosure 105 of the ground plane 104. In additional implementations, the antenna radiating element 110 can be reduced in size. For example, FIG. 3A is a cross-sectional view of an example implementation of a wireless antenna 102c with stratified architecture featuring an antenna radiating element 110 with a size that is significantly reduced in comparison with the enclosure 105 of the ground plane 104. As shown, the antenna radiating element 110 of the wireless antenna 102c can include tuning elements 117a and 117b. In one or more implementations, as discussed above, the tuning elements 117a, 117b serve to adjust the frequency of the antenna radiating element 110. Moreover, the wireless antenna 102c also includes a flex 116 that supports the antenna radiating element 110 beneath the ground plane 104. As discussed above, in some implementations, the flex 116 electrically connects the ground plane 104 to the antenna radiating element 110. In additional implementations, the flex 116 does not electrically connect the ground plane 104 to the antenna radiating element 110. Typically, the flex 116 connects any sensors included as part of the antenna radiating element 110 to the main logic board 106 in the ground plane 104.

FIGS. 3B and 3C show bottom perspective views of the stratified wireless antenna 102c. As shown, the wireless antenna 102b can include tuning elements 117a, 117b, 117c, and 117d positioned along the perimeter of the reduced-size antenna radiating element 110. In additional implementations, the wireless antenna 102b may include fewer tuning elements or more tuning elements. Additionally, in further implementations, tuning elements may be positioned differently such as at a middle-point of the sides of the antenna radiating element 110. In one or more implementations, the reduced-size antenna radiating element 110 may include a sensor panel for reading a wearer's pulse, body temperature, etc.

FIG. 3D is an open perspective view further showing the tuning elements 117a-117d radiating from the reduced-size antenna radiating element 110 of the stratified wireless antenna 102c. As shown, the tuning elements 117a-117d can extend perpendicularly from a perimeter of the antenna radiating element 110, while remaining electrically separated from the ground plane 104. In this implementation, the wireless antenna 102b also includes a second antenna radiating element 114 positioned above the ground plane 104. Regardless of the size of the antenna radiating element 110 in the stratified antenna architecture, a gap or slot will exist between the antenna radiating element 110 and the ground plane 104 such that the electrical field closing from the antenna radiating element 110 to the ground plane 104 can originate from the gap or slot.

As discussed above, the wireless antennas 102b, 102c featuring the stratified architecture can include tuning elements (e.g., the tuning elements 117a-117e) to help increase the range and accuracy of the antenna radiating element 110. In one or more implementations, these tuning elements can feature various architectures. For example, as shown in FIG. 4A, a tuning element 402 can include a spring finger architecture. In at least one implementation, the spring finger tuning element 402 can require clearance around the spring finger 405. The spring finger tuning element 402 may feature no impedance control as the spring finger 405 is part of the antenna. In some implementations, however, the spring finger tuning element 402 may be more prone to variation at mass production. In some implementations, antenna matching components may be placed on the main logic board 106 since the spring finger tuning element 402 is already part of the antenna radiating element 110.

In other implementations, as shown in FIG. 4B, the tuning element 404 may include a flexible printed circuit 406. For example, the flexible printed circuit tuning element 404 may be intended for narrow areas within a wireless antenna. In one or more implementations, the flexible printed circuit tuning element 404 can maintain a stable fifty Ohm radio frequency line until the feed point to the antenna radiating element 110. The flexible print circuit tuning element 404 may further be more stable at mass production. In some implementations, when using a 50 Ohm controlled flex (e.g., such as the flex 116 shown in FIGS. 3B and 3C), the antenna matching components may be placed on the antenna radiating element 110.

As mentioned above, a wireless antenna featuring a stratified architecture can be effectively integrated into a wearable device with a small form factor such as a wrist-wearable device (e.g., a smart watch). FIG. 5 illustrates such a wrist-wearable device 502 on the wrist 510 of a wearer. For example, the wrist-wearable device 502 can include a first module 504 (e.g., a top portion) including the ground plane 104 and a second module 506 (e.g., a bottom portion) including the antenna radiating element 110. In a preferred implementation, the wrist-wearable device 502 can further include an EMG flex 508 that is choked/isolated from the first module 504 and the second module 506. In additional implementations, the EMG flex 508 may be shorted to the ground plane 104. This may limit design freedom. Despite this, some design freedom may be gained by ensuring the short location of the EMG flex 508 is coincident with the location of the flex 116. In that implementation, that side of the antenna radiating element 110 (e.g., the same side as the flex 116) corresponds to the ground plane 104 and is therefore more isolated from the EMG flex 508.

As further shown in FIG. 5, the antenna radiating element 110 in the second module 506 can be in physical contact (e.g., capacitively coupled) with the wearer's wrist 510. Due to this contact between the second module 506 and the wearer's tissue (e.g., bare skin), the overall antenna volume of the antenna radiating element 110 is increased. By increasing the antenna volume of the antenna radiating element, the performance of the wrist-wearable device 502 is also increased. In additional implementations, the antenna radiating element 110 in the second module 506 may rely on electrical contact with the wearer's wrist 510, rather than relying on capacitive coupling. For example, the second module 506 may be all metal, therefore having electrical contact with the skin of the wearer's wrist 510. If the second module 506 include a metal element with a non-conductive outer layer (e.g., plastic), the second module 506 may rely on capacitive coupling with the wearer's wrist 510.

In one or more implementations, the ground plane 104 in the first module 504 can be maximized by electrically combining the elements in the first module 504 (e.g., the enclosure, master logic board, battery, speaker, microphones, camera, flexes). Additionally, the second module 506 can include a dedicated planar element supporting additional wireless protocols such as LTE, GPS, and WiFi. In additional implementations, the second module 506 can include a sensor panel. Regardless of the contents of the first module 504 and the second module 506, the first module 504 and the second module 506 remain electrically isolated while the wrist-wearable device 502 includes a gap or cleared volume between the first module 504 and the second module 506.

As mentioned above, the first module 504 and the second module 506 are electrically isolated. As such, the first module 504 can include the master logic board grounded to an enclosure—in as many points as possible. Moreover the master logic board in the first module 504 can increase in size based on the size of the enclosure in the first module 504. Any modules connected to the master logic board may also be grounded to the enclosure.

In summary, the stratified antenna architecture featured in the wireless antenna 102a, the wireless antenna 102b, and the wireless antenna 102c maximizes antenna volume for wearable devices with small form factors. For example, and as discussed above, the wireless antennas 102a-102c include a ground plane 104 and an antenna radiating element 110 that are electrically isolated. As such, the radiation from the antenna radiating element 110 originates from an edge/opening/slot between the antenna radiating element 110 and the ground plane 104 by the electrical fields closing from the antenna radiating element 110 to the ground plane 104. Moreover, due to the capacitive coupling between the antenna radiating element 110 and the tissue of the wearer, the electrical fields close from the wearer's tissue (e.g., the wearer's arm) to the ground plane 104. This increases the volume of the antenna radiating element 110 which directly increases the efficiency of the antenna radiating element 110.

### Example Embodiments

Example 1: A wireless antenna may include a ground plane, and an antenna radiating element capacitively coupled to tissue of a user, wherein the ground plane and the antenna radiating element are electrically isolated.

Example 2: The wireless antenna of Example 1, wherein the ground plane and the antenna radiating element are part of a wrist-wearable device such that the antenna radiating element is capacitively coupled to a bare arm of the user.

Example 3: The wireless antenna of any of Examples 1 and 2, wherein the ground plane is connected to a main logic board.

Example 4: The wireless antenna of any of Examples 1-3, wherein the main logic board is grounded to an enclosure.

Example 5: The wireless antenna of any of Examples 1-4, wherein the enclosure contains a battery in addition to the main logic board.

Example 6: The wireless antenna of any of Examples 1-5, wherein the antenna radiating element is connected to a sensor board.

Example 7: The wireless antenna of any of Examples 1-6, wherein the ground plane and the antenna radiating element are electrically isolated by a physical gap between the ground plane and the antenna radiating element.

Example 8: The wireless antenna of any of Examples 1-7, wherein a volume of the antenna radiating element is suitable for low frequency bands.

Example 9: The wireless antenna of any of Examples 1-8, wherein the ground plane is positioned above, but separate from, the antenna radiating element.

Example 10: A wrist-wearable device may include a top portion including a ground plane that includes an enclosure containing at least a main logic board and a battery, a bottom portion including an antenna radiating element, wherein the wrist-wearable device includes at least one opening between the top portion and the bottom portion, and the ground plane and the antenna radiating element are electrically isolated by a physical gap.

Example 11: The wrist-wearable device of Example 10, wherein the antenna radiating element in the bottom portion is capacitively coupled to a bare arm of a user.

Example 12: The wrist-wearable device of any of Examples 10 and 11, wherein the bottom portion further includes a sensor board.

Example 13: The wrist-wearable device of any of Examples 10-12, wherein the sensor board and the antenna radiating element are electrically connected.

Example 14: The wrist-wearable device of any of Examples 10-13, wherein the main logic board is grounded to the enclosure.

Example 15: The wrist-wearable device of any of Examples 10-14, wherein the enclosure further contains additional modules that are connected to the main logic board and grounded to the enclosure.

Example 16: The wrist-wearable device of any of Examples 10-15, wherein the main logic board, the battery, and the additional modules are connected within the ground plane at identical potentials.

Example 17: The wrist-wearable device of any of Examples 10-16, wherein the antenna radiating element includes a bottom antenna element and one or more tuning elements.

Example 18: The wrist-wearable device of any of Examples 10-17, wherein the one or more tuning elements extend perpendicularly from the bottom antenna element.

Example 19: The wrist-wearable device of any of Examples 10-18, wherein the one or more tuning elements are positioned along a periphery of the bottom antenna element.

Example 20: A wireless antenna may include a ground plane including an enclosure containing at least a main logic board and a battery, a top antenna radiating element, and a bottom antenna radiating element, wherein the bottom antenna radiating element is positioned below the ground plane and electrically isolated from the ground plane by a second physical gap while being capacitively coupled to a bare arm of a user.

FIG. 6A illustrates an exemplary human-machine interface (also referred to herein as an EMG control interface) configured to be worn around a user's lower arm or wrist as a wearable system 600. In this example, wearable system 600 may include sixteen neuromuscular sensors 610 (e.g., EMG sensors) arranged circumferentially around an elastic band 620 with an interior surface 630 configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 6B illustrates a cross-sectional view through one of the sensors of the wearable device shown in FIG. 6A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 610 is discussed in more detail below with reference to FIGS. 7A and 7B.

FIGS. 7A and 7B illustrate an exemplary schematic diagram with internal components of a wearable system with EMG sensors. As shown, the wearable system may include a wearable portion 710 (FIG. 7A) and a dongle portion 720 (FIG. 7B) in communication with the wearable portion 710 (e.g., via BLUETOOTH or another suitable wireless communication technology). As shown in FIG. 7A, the wearable portion 710 may include skin contact electrodes 711, examples of which are described in connection with FIGS. 6A and 6B. The output of the skin contact electrodes 711 may be provided to analog front end 730, which may be configured to perform analog processing (e.g., amplification, noise reduction, filtering, etc.) on the recorded signals. The processed analog signals may then be provided to analog-to-digital converter 732, which may convert the analog signals to digital signals that can be processed by one or more computer processors. An example of a computer processor that may be used in accordance with some embodiments is microcontroller (MCU) 734, illustrated in FIG. 7A. As shown, MCU 734 may also include inputs from other sensors (e.g., IMU sensor 740), and power and battery module 742. The output of the processing performed by MCU 734 may be provided to antenna 750 for transmission to dongle portion 720 shown in FIG. 7B.

Dongle portion 720 may include antenna 752, which may be configured to communicate with antenna 750 included as part of wearable portion 710. Communication between antennas 750 and 752 may occur using any suitable wireless technology and protocol, non-limiting examples of which include radiofrequency signaling and BLUETOOTH. As shown, the signals received by antenna 752 of dongle portion 720 may be provided to a host computer for further processing, display, and/or for effecting control of a particular physical or virtual object or objects.

Although the examples provided with reference to FIGS. 6A-6B and FIGS. 7A-7B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A wireless antenna comprising:
a ground plane; and
an antenna radiating element capacitively coupled to tissue of a user,
wherein the ground plane and the antenna radiating element are electrically isolated.

2. The wireless antenna of claim 1, wherein the ground plane and the antenna radiating element are part of a wrist-wearable device such that the antenna radiating element is capacitively coupled to a bare arm of the user.

3. The wireless antenna of claim 1, wherein the ground plane is connected to a main logic board.

4. The wireless antenna of claim 3, wherein the main logic board is grounded to an enclosure.

5. The wireless antenna of claim 4, wherein the enclosure contains a battery in addition to the main logic board.

6. The wireless antenna of claim 1, wherein the antenna radiating element is connected to a sensor board.

7. The wireless antenna of claim 1, wherein the ground plane and the antenna radiating element are electrically isolated by a physical gap between the ground plane and the antenna radiating element.

8. The wireless antenna of claim 1, wherein a volume of the antenna radiating element is suitable for low frequency bands.

9. The wireless antenna of claim 1, wherein the ground plane is positioned above, but separate from, the antenna radiating element.

10. A wrist-wearable device comprising:
a top portion comprising a ground plane that comprises an enclosure containing at least a main logic board and a battery; and
a bottom portion comprising an antenna radiating element,
wherein the wrist-wearable device includes at least one opening between the top portion and the bottom portion, and
the ground plane and the antenna radiating element are electrically isolated by a physical gap.

11. The wrist-wearable device of claim 10, wherein the antenna radiating element in the bottom portion is capacitively coupled to a bare arm of a user.

12. The wrist-wearable device of claim 10, wherein the bottom portion further comprises a sensor board.

13. The wrist-wearable device of claim 12, wherein the sensor board and the antenna radiating element are electrically connected.

14. The wrist-wearable device of claim 10, wherein the main logic board is grounded to the enclosure.

15. The wrist-wearable device of claim 10, wherein the enclosure further contains additional modules that are connected to the main logic board and grounded to the enclosure.

16. The wrist-wearable device of claim 15, wherein the main logic board, the battery, and the additional modules are connected within the ground plane at identical potentials.

17. The wrist-wearable device of claim 10, wherein the antenna radiating element comprises a bottom antenna element and one or more tuning elements.

18. The wrist-wearable device of claim 17, wherein the one or more tuning elements extend perpendicularly from the bottom antenna element.

19. The wrist-wearable device of claim 18, wherein the one or more tuning elements are positioned along a perimeter of the bottom antenna element.

20. A wireless antenna comprising:
a ground plane comprising an enclosure containing at least a main logic board and a battery;
a top antenna radiating element; and
a bottom antenna radiating element,
wherein the top antenna radiating element is positioned above the ground plane and electrically isolated from the ground plane by a first physical gap, and
wherein the bottom antenna radiating element is positioned below the ground plane and electrically isolated from the ground plane by a second physical gap while being capacitively coupled to a bare arm of a user.
